(19) United States
(12) Patent Application Publication
(10) Pub. No.: US 2026/0287895 A1
(43) Pub. Date: Sep. 24, 2026

(54) OPTICAL DEVICE AND NEAR-EYE DISPLAY APPARATUS

(71) Applicant: BEIJING OPTIX LIMITED, Beijing (CN)

(72) Inventors: Guanyi YAN, Beijing (CN); Yunfeng JIN, Beijing (CN)

(73) Assignee: BEIJING OPTIX LIMITED, Beijing (CN)

(21) Appl. No.: 19/440,512

(22) Filed: Jan. 5, 2026

(30) Foreign Application Priority Data
Feb. 27, 2025 (CN) 202510231382.7

(51) Int. Cl. G02B 27/01

(52) U.S. Cl. CPC G02B 27/0172; G02B 27/0176; G02B 2027/0127; G02B 2027/0154

(57) ABSTRACT

An optical device includes a light guide component and a focusing assembly. The focusing assembly includes: a semi-transmissive and semi-reflective face and a reflecting face which are oppositely arranged, the semi-transmissive and semi-reflective face is arranged within the light guide component, and the reflecting face is arranged on a side of the light guide component away from a coupling-out side, and is spaced apart from the light guide component; and a driving mechanism for driving the reflecting face to move relative to the semi-transmissive and semi-reflective face, the semi-transmissive and semi-reflective face and the reflecting face are both curved faces. A light in the light guide component propagates to the semi-transmissive and semi-reflective face, is reflected by the semi-transmissive and semi-reflective face to the reflecting face, is reflected by the reflecting face, and then transmitted through the semi-transmissive and semi-reflective face and emitted from the light guide component.

### CROSS REFERENCE TO RELATED APPLICATIONS

This application claims priority to Chinese Patent Application No. 202510231382.7 filed on Feb. 27, 2025, the entire contents of which is incorporated herein by reference.

### TECHNICAL FIELD

The present disclosure relates to the field of optical technologies, and in particular to an optical device and a near-eye display apparatus.

### BACKGROUND

Conventional light-guiding optical elements need collimated parallel light to enter and propagate in the waveguide, and after the parallel light is coupled out, it will enter the human eye and be imaged at infinity, that is, the image seen by the human eye is an image at infinity.

For the image seen by human eye in the real world, the nearest distance is about 250 mm, and the farthest distance is infinite. At present, the picture displayed by the waveguide is very different from the real focus position of human eye, which brings the conflict of convergence adjustment.

In natural vision, adjustment and convergence often work together, and the degree of convergence will affect the adjustment of the lens of the eye, and vice versa, thus ensuring flexible and powerful vision. When observing a distant object, the lens of the eyeball will relax and the line of sight will be parallel to keep the focus at a distance. However, when observing a nearby object, the eye will shrink the lens to adjust the focal length, so that the line of sight can focus on the object. If the brain receives a mismatch between eye adjustment and convergence, a vergence-accommodation conflict (VAC) will occur, which will cause pressure on the eye.

### SUMMARY

The present disclosure provides an optical device and a near-eye display apparatus, to improve the using effects and performance of the optical device.

According to a first aspect of embodiments of the present disclosure, there is provided an optical device, including: a light guide component and a focusing assembly; where the focusing assembly includes: a semi-transmissive and semi-reflective face and a reflecting face which are oppositely arranged, where the semi-transmissive and semi-reflective face is arranged within the light guide component, and the reflecting face is arranged on a side of the light guide component away from a coupling-out side, and is spaced apart from the light guide component; and a driving mechanism for driving the reflecting face to move relative to the semi-transmissive and semi-reflective face, where the semi-transmissive and semi-reflective face and the reflecting face are both curved faces; where a light in the light guide component propagates to the semi-transmissive and semi-reflective face, is reflected by the semi-transmissive and semi-reflective face to the reflecting face, is reflected by the reflecting face, and then transmitted through the semi-transmissive and semi-reflective face and emitted from the light guide component.

In the technical solution, by adopting the matching of the semi-transmissive and semi-reflective face and the reflecting face, the depth of field presented by the light when irradiated into the pupil of the user can be adjusted, so that the adjustment of the depth of field from near to infinity can be realized, and the experience effect of the user is improved.

In an embodiment, the semi-transmissive and semi-reflective face is a spherical face, an aspherical face or a free-form face.

The reflecting face is a spherical face, an aspherical face or a free-form face corresponding to the semi-transmissive and semi-reflective face.

In an embodiment, the semi-transmissive and semi-reflective face and the reflecting face meet the following formula:

R1/2+d1−R2/2=0;

s2′=(R1*(R1+2d1))/(d2−d1); s2>200 mm;

where R1 is a curvature radius of the semi-transmissive and semi-reflective face, R2 is a curvature radius of the reflecting face, d1 is a minimum distance between the semi-transmissive and semi-reflective face and the reflecting face, d2 is a maximum distance between the semi-transmissive and semi-reflective face and the reflecting face, and s2′ is a focal length of a lens formed by the semi-transmissive and semi-reflective face and the reflecting face.

In an embodiment, the semi-transmissive and semi-reflective face is a concave curved face, and a concave direction of the concave curved face is away from the coupling-out side of the light guide component.

In an embodiment, two ends of the semi-transmissive and semi-reflective face extend to two opposite faces of the light guide component, and a vertical plane of a central axis of the semi-transmissive and semi-reflective face is inclined relative to the two opposite faces of the light guide component.

In an embodiment, the reflecting face is a semi-transmissive and semi-reflective face, or a polarized reflective face.

In an embodiment, a reflectivity of the semi-transmissive and semi-reflective face ranges from 2% to 10%.

In an embodiment, the optical device further includes a curved mirror located outside the light guide component, where a side of the curved mirror away from the light guide component is the reflecting face, and a side of the curved mirror facing the light guide component is a plane face.

In an embodiment, the driving mechanism includes a linear motor, and the curved mirror is fixedly connected to a moving end of the linear motor.

In an embodiment, the driving mechanism includes a lead screw and a driving motor for driving the lead screw to rotate, and the curved mirror is driven by the lead screw.

According to a second aspect of embodiments of the present disclosure, there is provided a near-eye display apparatus, including a light generator and the optical device of any one of the above embodiments; where a light emitted by the optical device propagates into the light guide component.

In the technical solution, by adopting the matching of the semi-transmissive and semi-reflective face and the reflecting face, the depth of field presented by the light when irradiated into the pupil of the user can be adjusted, so that the adjustment of the depth of field from near to infinity can be realized, and the experience effect of the user is improved.

### BRIEF DESCRIPTION OF THE DRAWINGS

FIG. 1 shows an application scenario of an optical device in related arts.

FIG. 2 is a structural schematic diagram illustrating an optical device according to an embodiment of the present disclosure.

FIG. 3 and FIG. 4 are simulation diagrams illustrating an optical device according to an embodiment of the present disclosure.

### DETAILED DESCRIPTION OF THE EMBODIMENTS

To make the object, technical solution and advantages of the present disclosure clearer, the embodiments of the present disclosure will be described below in detail in combination with accompanying drawings.

It is to be noted that unless otherwise defined, the technical or scientific terms used in the present disclosure shall have the usual meanings understood by those of ordinary skill in the field to which the present disclosure belongs. The terms “first”, “second”, and similar terms used in the description and claims of the present disclosure do not indicate any of order, quantity, and importance, but are only used to distinguish different components. Terms such as “include” or “include”, and the like, are intended to mean that the elements or objects that appear before the term include those listed after the term and their equivalents, without excluding other elements or objects. Terms such as “connect” or “couple”, and the like, are not limited to physical or mechanical connections, but may include electrical connections, whether directly or indirectly. Terms “up”, “down”, “left” and “right” are only used to indicate the relative positional relationship. When the absolute position of the described object changes, the relative positional relationship may also change accordingly.

For the convenience of understanding the optical device provided by the embodiments of the present disclosure, its application scenario will be explained first. The display device provided by the embodiments of the present disclosure is applied to different near-eye display systems such as Augmented Reality (AR) or Virtual Reality (VR) to achieve virtual display. However, the conventional near-eye display system generally has a problem that the displayed image cannot have depth of field.

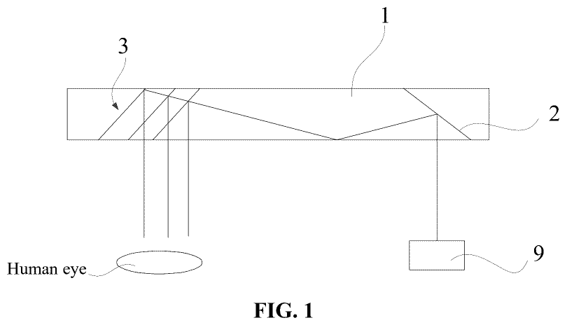

As shown in FIG. 1, FIG. 1 shows an application scenario of an optical device in related arts. The conventional optical device includes a light guide component 1, a light coupling-in device 2, a light coupling-out device 3 and a light generator 9. The light generator 9 is used to emit light for displaying images. The light coupling-in device 2 is used to couple the light emitted by the light generator 9 into the light guide component 1. The light guide component 1 is used for propagating light, and it has two total internal reflection faces which are oppositely arranged, and the light in the light guide component 1 can propagate light through the total internal reflection of the total internal reflection faces. The light coupling-out device 3 is used to couple out the light in the light guide 1 to the eye of the user, so that the user can observe the image displayed by the light generator.

As can be seen from FIG. 1, when the image is displayed, it only depends on the light of the image in the light generator for corresponding display, and the optical device cannot adjust the depth of field, resulting in poor display effect. Therefore, the embodiment of the present disclosure provides an optical device to improve the viewing effect of users. The following is a detailed description with specific drawings and embodiments.

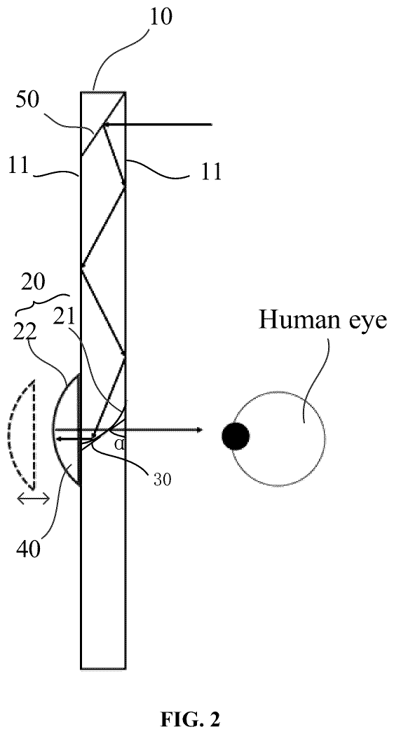

As shown in FIG. 2, FIG. 2 is a structural schematic diagram illustrating an optical device according to an embodiment of the present disclosure. The optical device provided by the embodiment of the present disclosure mainly includes a light guide component 10 and a focusing assembly 20, where the light guide component 10 is used to propagate light in the light guide component 10 by total reflection, and the focusing assembly 20 is used to adjust the depth of field of light when the light propagates from the light guide light component 10 to the human eye.

The light guide component 10 provided by the embodiment of the present disclosure is a waveguide, which has two opposite faces, and the two opposite faces are total internal reflection faces 11, and light can propagate through the two total internal reflection faces 11 in the waveguide. When the light generator couples the light into the waveguide through the coupling-in grating 50, the light can propagate through the total internal reflection face 11 and be coupled out through the focusing assembly 20. That is, in the solution in the present disclosure, the focusing assembly 20 serves as a coupling-out component on the one hand, and is configured to adjust the focal length on the other hand, so as to change the depth of field when human eye observes images.

In the specific configuration, the focusing assembly 20 includes two parts that cooperate with each other, i.e., a semi-transmissive and semi-reflective face 21 and a reflecting face 22. The semi-transmissive and semi-reflective face 21 and the reflecting face 22 are arranged oppositely, and the semi-transmissive and semi-reflective face 21 is located inside the light guide component 10, and the reflecting face 22 is located outside the light guide component 10. As shown in FIG. 2, for the configuration of the reflecting face 22, the reflecting face 22 is located on a side of the light guide component 10 away from the coupling-in grating 50. That is, the reflecting face 22 is located on the side of the light guide component 10 away from the pupil of the user.

When in use, a light in the light guide component 10 propagates to the semi-transmissive and semi-reflective face 21, is reflected by the semi-transmissive and semi-reflective face 21 to the reflecting face 22, is reflected by the reflecting face, and then transmitted through the semi-transmissive and semi-reflective face 21 and emitted from the light guide component 10. The semi-transmissive and semi-reflective face 21 is configured to reflect the light propagating in the light guide component 10, so that the light is coupled out of the light guide component 10 and propagated to the reflecting face 22, and the reflecting face 22 reflects the light back to the semi-transmissive and semi-reflective face 21, and the light passes through the light guide component 10 to the pupil of the user. According to the above-mentioned description, the semi-transmissive and semi-reflective face 21 in the embodiments of the present disclosure needs to meet the following requirements for transmission and reflection: only reflecting the light that is completely reflected from the light guide component 10 to the semi-transmissive and semi-reflective face 21, and only transmitting the light that is reflected from the reflecting face 22 to the semi-transmissive and semi-reflective face 21. Therefore, it can meet the requirement that the light propagating through total reflection in the light guide component 10 can be reflected out of the light guide 10 (coupled out of the light guide component 10) through the semi-transmissive and semi-reflective face 21, and the light can pass through the semi-transmissive and semi-reflective face 21 and the light guide component 10, propagate into the pupil of the user, and be imaged in the pupil of the user.

According to the above-mentioned description, in the embodiments of the present disclosure, the coordination between the reflecting face 22 and the semi-transmissive and semi-reflective face 21 can increase the path of light when propagating from the optical waveguide to the human eye, thereby increasing the imaging distance. When adjusting the distance between the reflecting face 22 and the semi-transmissive and semi-reflective face 21, the imaging distance can be adjusted, thereby improving the effect of viewing images by the user. For configuration of the semi-transmissive and semi-reflective face 21 and the reflecting face 22 are provided, the semi-transmissive and semi-reflective face 21 and the reflecting face 22 are both curved faces, and the concave sides of the semi-transmissive and semi-reflective face 21 and the reflecting face 22 are opposite to each other, so that the light can be converged and imaged in the pupil of the user.

In addition, the optical device provided in the present disclosure also includes a driving mechanism, which is configured to drive the reflecting face 22 to move relative to the semi-transmissive and semi-reflective face 21, and the distance between the reflecting face 22 and the semi-transmissive and semi-reflective face 21 can be adjusted along the moving direction of the reflecting face 22 illustrated by the double-headed arrow in FIG. 2. For example, when observing a distant object, the lens of the eyeball will relax and the line of sight will be parallel to keep the focus at a distance. However, when observing a nearby object, the eye will shrink the lens to adjust the focal length, so that the line of sight can focus on the object. Therefore, when the reflecting face 22 is adjusted, it can be adjusted according to the state of the lens of the eyeball. When the lens is relaxed, the driving mechanism is controlled to drive the reflecting face 22 away from the semi-transmissive and semi-reflective face 21. When the lens is in a contracted state, the driving mechanism is controlled to drive the reflecting face 22 close to the semi-transmissive and semi-reflective face 21. By adjusting the reflecting face 22, the imaging position of the optical device is matched with the lens state of the eyeball, so as to improve the viewing effect of the user.

According to the above-mentioned description, the optical device in the embodiments of the present disclosure can adjust, by adopting the matching of the semi-transmissive and semi-reflective face 21 and the reflecting face 22, the depth of field presented by the light when irradiated into the pupil of the user can be adjusted, so that the adjustment of the depth of field from near to infinity can be realized, and the effect experienced by the user is improved. That is, the optical device provided in the present disclosure can match the displayed picture with the real focus position of human eye, and improve the convergence adjustment conflict.

Continuing to refer to FIG. 2, when the semi-transmissive and semi-reflective face is a curved face, the reflecting face is a spherical face, an aspherical face or a free-form face corresponding to the semi-transmissive and semi-reflective face. Similarly, when the reflecting face 22 is a spherical face, the reflecting face 22 is a spherical face, an aspherical face or a free-form face corresponding to the semi-transmissive and semi-reflective face 21. Therefore, two parts with the same face can cooperate with each other to control the light path when the light is reflected between the two parts.

For configuration of the semi-transmissive and semi-reflective face 21, the semi-transmissive and semi-reflective face 21 is a concave curved face, and a concave direction of the concave curved face is away from the coupling-out side of the light guide component 10. When this structure is adopted, the light is converged by the curved structure of the semi-transmissive and semi-reflective face 21 and propagates to the reflecting face 22, so that it can be imaged in the pupil of the user by matching with the curved structure of the reflecting face 22.

For configuration of the semi-transmissive and semi-reflective face 21 and the reflecting face 22, the semi-transmissive and semi-reflective face 21 and the reflecting face 22 meet the following formula:

R1/2+d1−R2/2=0;

s2′=(R1*(R1+2d1))/(d2−d1); s2<200 mm;

where R1 is a curvature radius of the semi-transmissive and semi-reflective face 21, R2 is a curvature radius of the reflecting face 22, d1 is a minimum distance between the semi-transmissive and semi-reflective face 21 and the reflecting face 22, d2 is a maximum distance between the semi-transmissive and semi-reflective face 21 and the reflecting face 22, and s2′ is a focal length of a lens formed by the semi-transmissive and semi-reflective face 21 and the reflecting face 22.

The light propagating in the waveguide is similar to parallel light, so the object distance formed is close to infinity, and after it is incident on the semi-transmissive and semi-reflective face 21 in the waveguide, it will have the effect of convergence or divergence, and the Gaussian formula is met: f1′/s1′+f1/s1=1, f′/f=−n′/n, where f1 represents the object focal length, f1′ represents the image focal length, n represents the object refractive index, n′ represents the image refractive index, s1 represents the object distance, and s1′ represents the image distance. When the system is a reflecting mirror, n′=−n, f1/s1′+f1/s1=1. When s1 is infinite, s1′=f1.

After the first reflection of the light through the semi-transmissive and semi-reflective face 21, there is an image distance s1′, and the distance between the semi-transmissive and semi-reflective face 21 and the reflecting face 22 is d. Due to the reflection, the image distance becomes a secondary reflection: s2=s′+d. Continue to use Gaussian formula: f2′/s2′+f2/s2=1, f2′/f2=−n′/n, where f2 is the object focal length, f2′ is the image focal length, n is the object refractive index, n′ is the image refractive index, S2 is the object distance, and S2′ is the image distance. When the system is a reflecting mirror, n′=−n, f2/s2′+f2/s2=1; s2′=(f2*s2)/(s2−f2)=f1*f2/(f1+d−f2).

In the above formula, d is a variable value. When the reflecting face 22 is close to the waveguide (about 1 mm), the system image distance is required to be infinite, so f1+d-f2=0, that is, f1=f2+d. Because the whole system needs to switch freely between the finite image distance and the infinity, on the premise of f1+d1−f2=0, the finite distance should be satisfied: s2′=f1*f2/(f1+d2−f2), s2>200 mm; the relationship between s2′ and R1 and d2 is: s2′=(R1*(R1+2d1))/(d2−d1).

According to the above description, the semi-transmissive and semi-reflective face 21 and the reflecting face 22 provided by the embodiments of the present disclosure realize the switching between the finite image distance and the infinite image distance through the coordination of curvature and the coordination of the distance adjustment range between the two faces.

In an embodiment, two ends of the semi-transmissive and semi-reflective face 21 extend to two opposite faces of the light guide component 10, and a vertical plane 30 of a central axis of the semi-transmissive and semi-reflective face 21 is inclined relative to the two opposite faces of the light guide component 10. The vertical plane 30 of the central axis of the semi-transmissive and semi-reflective face 21 refers to a vertical plane corresponding to the connecting line between the center point of the semi-transmissive and semi-reflective face 21 and its center. As shown in FIG. 2, the dashed line refers to the vertical plane 30 of the central axis. As can be seen from FIG. 2, the vertical plane 30 of the central axis is relatively inclined with respect to the two faces of the light guide component 10, for example, an angle α between the vertical plane and one face satisfies: 0°<α<90°. For example, the angle α can be 30°, 50°, 70°, 80° and other different angles. When the above configuration of the semi-transmissive and semi-reflective face 21 is adopted, the propagation path of light can be changed through the semi-transmissive and semi-reflective face 21, and more light can be converged on the reflecting face 22.

In an embodiment, a reflectivity of the semi-transmissive and semi-reflective face 21 ranges from 2% to 10%. That is, a transmissivity of the semi-transmissive and semi-reflective face 21 ranges from 90% to 98%, and the reflectivity ranges from 2% to 10%. For example, the semi-transmissive and semi-reflective face 21 may have the reflectivity of 2%, 5%, 7%, 9% and 10%, correspondingly, the semi-transmissive and semi-reflective face 21 may have the transmissivity of 98%, 95%, 93%, 91% and 90%. In actual use, the semi-transmissive and semi-reflective face 21 with different transmissivity and reflectivity can be selected according to specific requirements.

In an embodiment, the reflecting face 22 can reflect light in different modes, for example, the reflecting face 22 also adopts a semi-transmissive and semi-reflective face, or the reflecting face 22 is a polarized reflective face, which can be applied to the optical device of the embodiments of the present disclosure, and is not specifically limited in the embodiments of the present disclosure.

Since the reflecting face 22 is located in the light guide component 10 as an independent structure, when the curved mirror 40 is provided, the optical device provided by the embodiments of the present disclosure further includes the curved mirror 40, which is located outside the light guide component 10. A side of the curved mirror 40 away from the light guide component 10 is the reflecting face 22. A side of the curved mirror 40 facing the light guide component 10 is a plane face. As shown in FIG. 2, the two opposite faces of the curved mirror 40 are respectively a curved face and a plane face, where the plane face faces the light guide component 10, and the curved face is away from the light guide component 10 and serves as the reflecting face 22. When the light propagates, it can directly pass through the plane face and shine on the reflecting face 22.

In an optional embodiment, the curved mirror 40 is made of the same material as the light guide component 10, so that the light guide component 10 and the curved mirror 40 can be made of one material.

For configuration of the driving mechanism, the driving mechanism can adopt different types of driving mechanisms, as long as it can drive the reflecting face 22 linearly. The linear direction is along the arrangement direction of the two total internal reflection faces 11 of the light guide component 10.

In an optional embodiment, the drive mechanism may include a linear motor, with the curved mirror 40 fixedly connected to the moving end of the linear motor to directly drive the curved mirror 40 to move through the linear motor. The moving distance of the curved mirror 40 can be achieved by controlling the moving distance of the linear motor. Of course, when the driving mechanism is connected to the curved mirror 40, the curved mirror 40 can be fixed on a supporting base, and the moving end of the linear motor is fixedly connected to the supporting base.

In an embodiment, the driving mechanism includes a lead screw and a driving motor for driving the lead screw to rotate, and the curved mirror 40 is driven by the lead screw. Specifically, when adopting this structure, the curved mirror 40 can be assembled on the supporting structure supporting the light guide component 10 and connected with the supporting structure in a sliding mode, and the sliding direction is along the arrangement direction of the two total internal reflection faces 11 of the light guide component 10. The nut in the lead screw of the driving mechanism is fixedly connected with the curved mirror 40, and the wire lever of the lead screw is connected with the output shaft of the driving motor. When the output shaft of the driving motor rotates, the nut can be driven to move by the wire lever, thereby adjusting the distance between the curved mirror 40 and the semi-transmissive and semi-reflective face 21.

It is to be understood that the driving mechanism of the above example is a common linear driving mechanism, so the schematic diagram of the driving mechanism is not illustrated in the embodiments of the present disclosure.

In order to facilitate the understanding of the optical device provided by the embodiments of the present disclosure, the imaging effect of the optical device will be described with the simulation result of a specific example.

For example, the thickness of the light guide component 10 is 1.5 mm, the angle between the vertical plane of the central axis of the semi-transmissive and semi-reflective face 21 in the light guide component 10 and the face of the light guide component 10 is 27°, and the curvature radius of the semi-transmissive and semi-reflective face 21 is 150 mm, which plays a divergent reflection role for parallel light, and the reflectivity of the semi-transmissive and semi-reflective face 21 is 5%, and the light is reflected after saving 5% of energy and emitted out of the light guide component 10.

After leaving the light guide component 10, the light passes through an optical material with a thickness of 1 mm to reach the surface of the reflecting face 22. A curvature radius of the reflecting face 22 is 125 mm. The reflecting face 22 is coated with a reflecting film designed to reflect light with a specific polarization direction. The light in the S direction is reflected by the reflecting film, and due to the convergence and reflection effect of the curved reflecting face 22 on optics, the light continues to propagate in the direction of the light guide component 10 after convergence, passes through the light component 10, and reaches the human eye.

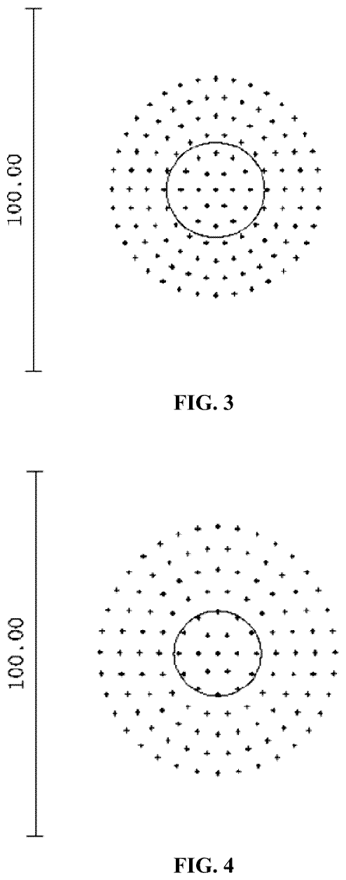

As shown in FIG. 3, when the reflecting face 22 located on the outer side of the light guide component 10 is 10 mm away from the surface of the light guide component 10, the light entering the human eye forms an image at a distance approaching infinity. As shown in FIG. 3, the resulting spot pattern exhibits a Root Mean Square (RMS) radius of 22 μm, with an excellent convergence effect.

As shown in FIG. 4, when the distance between the reflecting face 22 located on the outer side of the light guide component 10 and the surface of the light guide component 10 is adjusted to 0.6 mm, the light entering the human eye forms an image of about 250 mm, which is close to the nearest apparent distance of the human eye. As shown in FIG. 4, the resulting spot pattern exhibits an RMS radius of 25 μm, with an acceptable convergence effect.

According to the simulation example, when the reflecting face 22 moves by 9.4 mm, the image distance of the optical system is changed from infinity to 250 mm. By changing the matching distance of two components (the semi-transmissive and semi-reflective face 21 and the reflecting face 22), the virtual image distance is adjusted, and the effect of focal plane transformation in the current system is achieved.

The embodiments of the present disclosure provide a near-eye display apparatus including a light generator and the optical device of any one of the above embodiments; where a light emitted by the optical device propagates into the light guide component.

According to the above-mentioned description, the optical device in the embodiments of the present disclosure can adjust, by adopting the matching of the semi-transmissive and semi-reflective face 21 and the reflecting face 22, the depth of field presented by the light when irradiated into the pupil of the user can be adjusted, so that the adjustment of the depth of field from near to infinity can be realized, and the effect experienced by the user is improved. That is, the optical device provided in the present disclosure can match the displayed picture with the real focus position of the human eye, and improve the convergence adjustment conflict.

In an optional embodiment, the near-eye display apparatus provided by the embodiments of the present disclosure further includes a camera for collecting the lens state of the eye of the user and a data processing chip, which can know the viewing state of the user through the lens state photographed by the camera, and adjust the distance from the reflecting face to the light guide component according to the lens state, so that the position where the eye of the user is focused matches the position where the optical device images. It is to be understood that the corresponding relationship between the lens state and the distance from the reflecting face to the light guide component can be constructed by collecting information for many times before using the near-eye display apparatus. For example, when the lens is contracting, the distance between the reflecting face and the light guide component is adjusted until a clear image can be observed by the human eye. According to the different degrees of contraction or expansion of the lens, the reflecting face is correspondingly adjusted for each state of the lens, so as to construct the corresponding relationship between the distance from the reflecting face to the light guide component and different states of the lens.

One or more embodiments of this specification are intended to encompass all such substitutions, modifications, and variations falling within the broad scope of the appended claims. Therefore, any omission, modification, equivalent substitution, improvement, etc. made within the spirit and principles of one or more embodiments of this specification should be included in the scope of protection of the present disclosure.

The above descriptions are merely specific examples of the present disclosure to which the scope of protection of the present disclosure is not limited. Any changes or substitutions that easily occur to those skilled in the art in the technical scope of the present disclosure should fall in the scope of protection of the present disclosure. Therefore, the scope of protection of the present disclosure is indicated as in appended claims.

1. An optical device, comprising: a light guide component, and a focusing assembly;
wherein the focusing assembly comprises:
a semi-transmissive and semi-reflective face and a reflecting face which are oppositely arranged, wherein the semi-transmissive and semi-reflective face is arranged within the light guide component, and the reflecting face is arranged on a side of the light guide component away from a coupling-out side, and is spaced apart from the light guide component; and
a driving mechanism for driving the reflecting face to move relative to the semi-transmissive and semi-reflective face, wherein the semi-transmissive and semi-reflective face and the reflecting face are both curved faces;
wherein a light in the light guide component propagates to the semi-transmissive and semi-reflective face, is reflected by the semi-transmissive and semi-reflective face to the reflecting face, is reflected by the reflecting face, and then transmitted through the semi-transmissive and semi-reflective face and emitted from the light guide component.

2. The optical device of claim 1, wherein the semi-transmissive and semi-reflective face is a spherical face, an aspherical face or a free-form face; and
wherein the reflecting face is a spherical face, an aspherical face or a free-form face corresponding to the semi-transmissive and semi-reflective face.

3. The optical device of claim 2, wherein the semi-transmissive and semi-reflective face and the reflecting face meet the following formula:
R1/2+d1−R2/2=0;
s2′=(R1*(R1+2d1))/(d2−d1); s2>200 mm;
wherein R1 is a curvature radius of the semi-transmissive and semi-reflective face, R2 is a curvature radius of the reflecting face, d1 is a minimum distance between the semi-transmissive and semi-reflective face and the reflecting face, d2 is a maximum distance between the semi-transmissive and semi-reflective face and the reflecting face, and s2′ is a focal length of a lens formed by the semi-transmissive and semi-reflective face and the reflecting face.

4. The optical device of claim 2, wherein the semi-transmissive and semi-reflective face is a concave curved face, and a concave direction of the concave curved face is away from the coupling-out side of the light guide component.

5. The optical device of claim 4, wherein two ends of the semi-transmissive and semi-reflective face extend to two opposite faces of the light guide component, and a vertical plane of a central axis of the semi-transmissive and semi-reflective face is inclined relative to the two opposite faces of the light guide component.

6. The optical device of claim 2, wherein the reflecting face is a semi-transmissive and semi-reflective face, or a polarized reflective face.

7. The optical device of claim 6, wherein a reflectivity of the semi-transmissive and semi-reflective face ranges from 2% to 10%.

8. The optical device of claim 1, further comprising a curved mirror located outside the light guide component, wherein a side of the curved mirror away from the light guide component is the reflecting face, and a side of the curved mirror facing the light guide component is a plane face.

9. The optical device of claim 8, wherein the driving mechanism comprises a linear motor, and the curved mirror is fixedly connected to a moving end of the linear motor; or the driving mechanism comprises a lead screw and a driving motor for driving the lead screw to rotate, and the curved mirror is driven by the lead screw.

10. A near-eye display apparatus, comprising a light generator; and an optical device;
wherein the optical device comprises: a light guide component and a focusing assembly;
wherein the focusing assembly comprises:
a semi-transmissive and semi-reflective face and a reflecting face which are oppositely arranged, wherein the semi-transmissive and semi-reflective face is arranged within the light guide component, and the reflecting face is arranged on a side of the light guide component away from a coupling-out side, and is spaced apart from the light guide component; and
a driving mechanism for driving the reflecting face to move relative to the semi-transmissive and semi-reflective face, wherein the semi-transmissive and semi-reflective face and the reflecting face are both curved faces;
wherein a light in the light guide component propagates to the semi-transmissive and semi-reflective face, is reflected by the semi-transmissive and semi-reflective face to the reflecting face, is reflected by the reflecting face, and then transmitted through the semi-transmissive and semi-reflective face and emitted from the light guide component; and
wherein a light emitted by the optical device propagates into the light guide component.

11. The near-eye display apparatus of claim 10, wherein the semi-transmissive and semi-reflective face is a spherical face, an aspherical face or a free-form face; and
wherein the reflecting face is a spherical face, an aspherical face or a free-form face corresponding to the semi-transmissive and semi-reflective face.

12. The near-eye display apparatus of claim 11, wherein the semi-transmissive and semi-reflective face and the reflecting face meet the following formula:
R1/2+d1−R2/2=0;
s2′=(R1*(R1+2d1))/(d2−d1); s2>200 mm;
wherein R1 is a curvature radius of the semi-transmissive and semi-reflective face, R2 is a curvature radius of the reflecting face, d1 is a minimum distance between the semi-transmissive and semi-reflective face and the reflecting face, d2 is a maximum distance between the semi-transmissive and semi-reflective face and the reflecting face, and s2′ is a focal length of a lens formed by the semi-transmissive and semi-reflective face and the reflecting face.

13. The near-eye display apparatus of claim 11, wherein the semi-transmissive and semi-reflective face is a concave curved face, and a concave direction of the concave curved face is away from the coupling-out side of the light guide component.

14. The near-eye display apparatus of claim 13, wherein two ends of the semi-transmissive and semi-reflective face extend to two opposite faces of the light guide component, and a vertical plane of a central axis of the semi-transmissive and semi-reflective face is inclined relative to the two opposite faces of the light guide component.

15. The near-eye display apparatus of claim 11, wherein the reflecting face is a semi-transmissive and semi-reflective face, or a polarized reflective face.

16. The near-eye display apparatus of claim 15, wherein a reflectivity of the semi-transmissive and semi-reflective face ranges from 2% to 10%.

17. The near-eye display apparatus of claim 10, further comprising a curved mirror located outside the light guide component, wherein a side of the curved mirror away from the light guide component is the reflecting face, and a side of the curved mirror facing the light guide component is a plane face.

18. The near-eye display apparatus of claim 17, wherein the driving mechanism comprises a linear motor, and the curved mirror is fixedly connected to a moving end of the linear motor;
or the driving mechanism comprises a lead screw and a driving motor for driving the lead screw to rotate, and the curved mirror is driven by the lead screw.
